(19) United States
(12) Patent Application Publication
(10) Pub. No.: US 2005/0142525 A1
(43) Pub. Date: Jun. 30, 2005

(54) Surgical training system for laparoscopic procedures

(76) Inventors: Stephane Cotin, Belmont, MA (US); Nicholas Stylopoulos, Mansfield, MA (US); Mark Ottensmeyer, Cambridge, MA (US); Paul Neumann, Boston, MA (US); Ryan Bardsley, Deering, NH (US); Steven Dawson, Carlisle, MA (US)

Correspondence Address: Paul D. Durkee;Daly, Crowley & Mofford, LLP, Suite 101, 275 Turnpike Street, Canton, MA, 02021-2354, US

(21) Appl. No.: 10/797,874

(22) Filed: Mar. 10, 2004

Related U.S. Application Data
(60) Provisional application No. 60/453,170, filed on Mar. 10, 2003.

(51) Int. Cl. G09B 23/28

(52) U.S. Cl. 434/262

(57) ABSTRACT

A surgical training system includes a tracking system for tracking the position of one or more instruments during a training procedure and objectively evaluating trainee performance based upon one or more metrics using the instrument position information. Instrument position information for the training procedure can be compared against instrument position information for an expert group to generate standardized scores. Various training object can provide realistic haptic feedback during the training procedures.

### CROSS REFERENCE TO RELATED APPLICATIONS

The present application claims the benefit of U.S. Provisional Patent Application No. 60/453,170, filed on Mar. 10, 2003, which is incorporated herein by reference.

### STATEMENT REGARDING FEDERALLY SPONSORED RESEARCH

The Government may have certain rights in the invention pursuant to U.S. Army Medical Research Acquisition Activity under contract No. DAMD 17-02-2-0006.

### FIELD OF THE INVENTION

The present invention relates generally to surgery and, more particularly, to surgical training systems.

### BACKGROUND OF THE INVENTION

As is known in the art, there are a variety of known surgical training systems. Many such training systems include computer technology to enhance the training experience. Some conventional computer-assisted systems can quantify a variety of parameters, such as instrument motion, applied forces, instrument orientation, and dexterity, which cannot be measured with non-computer-based training systems. With proper assessment and validation, such systems can provide both initial and ongoing assessment of operator skill throughout one's career, while enhancing patient safety through reduced risk of intraoperative error. Additionally, a computerized trainer can provide either terminal (post-task completion) or concurrent (real time) feedback during the training episodes, enhancing skills acquisition. Over the past decade or so, several computer-based surgical trainers have been developed. However, none of them has been widely accepted and officially integrated into a medical curriculum or any other sanctioned training course.

Among the impediments to simulator acceptance by organized medicine are the lack of realism and the lack of appropriate performance assessment methodologies. The requisite level of realism in medical simulators has not been determined. Surgeons generally believe that the optimal trainer is one that is capable of reproducing the actual operative conditions in order to immerse the trainee in a virtual world that is an accurate representation of the real world. Currently available technology cannot provide virtual reality systems with “real-world” authenticity.

Until relatively recently, there was a tendency to view performance assessment and metrics in simplistic terms. The first computer-based trainers and the non-computer-based laparoscopic skills trainers incorporated empirical outcome measures as an indirect way to evaluate performance and learning. However, the metrics used in these trainers lack clinical significance. That is, an effective metric should not only provide information about performance, but also identify the key success or failure factors during performance, and the size and the nature of any discrepancy between expert and novice performance. Thus, an effective metric should indicate remedial actions that can be taken in order to resolve these discrepancies. Additionally, currently available training systems lack a standardized performance assessment methodology.

It is known that without an objective, standardized and clinically meaningful feedback system, the simplistic and abstract tasks used in the majority of available training systems are not sufficient to learn the subtleties of delicate laparoscopic tasks and manipulation, such as suturing. Even accepting that a certain level of abstraction is permitted for surgical skills training, there are other fundamental issues of interest. For example, the presence of force feedback and/or visual feedback are factors in the level of success in surgical training.

Force feedback is a component of many types of surgical manipulation. In open surgery for example, force feedback permits the surgeon to apply appropriate tension during delicate dissection and exposure and avoid damage to surrounding structures. While the magnitude of force feedback is diminished in laparoscopic manipulations, surgeons adapt to this inherent disadvantage by developing clever psychological adaptation mechanisms and special perceptual and motor skills. So-called conscious-inhibition (gentleness) is considered one of the major adaptation mechanisms. Conscious-inhibition implies that surgeons learn to interpret visual information adequately and based upon these cues, sense force, despite the lack of force feedback. This adaptive transformation from the visual sense to touch can be referred to as “visual haptics.” Using “visual haptics” a surgeon or other physician is able to appropriately modify the amount of force mechanically applied to tissues primarily from visual cues, such as tissue deformations. For example, a surgeon may not be able to feel with his/her hands a structure that is stretched when retracted, but he/she may “feel” the retraction of the structure by watching subtle indicators such as color, contour, and adjacent tissue integrity on the monitor.

The introduction of force feedback in computer-based learning systems is challenging and requires knowledge of instrument-tissue interaction (computation of forces that are applied during surgical manipulations) and human-instrument interaction (design and development of an interface). To date, there are no known efficient and cost-effective solutions.

In addition, the requirement for realistic visual feedback implies that the computerized representation of the real world be able to depict tissue deformations accurately. The creation of virtual deformable objects is a cumbersome and time-consuming process that requires the development of a mathematical model and the knowledge of the object behavior during the different types of manipulation.

### SUMMARY OF THE INVENTION

The present invention provides a surgical training system having an instrument tracking module for tracking the position of a surgical instrument during a training procedure as a trainee manipulates a simulated anatomical workpiece providing realistic haptic feedback. The position of the surgical instrument over the course of the procedure can be used to objectively assess trainee performance. With this arrangement, the quality of the surgical training and performance evaluation is enhanced. While the invention is primarily shown and described in conjunction with training in laparoscopic procedures, it is understood that the invention is applicable to a variety of surgical procedures in which it is desirable to provide realistic haptic feedback and/or objective technique assessment.

In one aspect of the invention, a surgical training system includes a frame extending from a base to support an instrument tracking module for tracking the position of at least one surgical instrument. The base can receive a platform having a simulated anatomical workpiece providing substantially realistic feedback. The system further includes a workstation for processing the instrument position information over the course of the training procedure. The workstation can objectively assess the trainee's instrument position information by comparison to a generic expert's position information. In one embodiment, a series of metrics are used to assess trainee performance. Exemplary metrics include depth perception, smoothness, orientation, path length for each instrument, and elapsed time.

In another aspect of the invention, a method of surgical training includes tracking a position of a surgical instrument during a training procedure in which a user manipulates a simulated anatomical workpiece providing substantially realistic haptic feedback. The method further includes objectively assessing a performance of the user by analyzing the position of the surgical instrument during the training procedure by comparison to a position of the surgical instrument during the training procedure derived from experts in the training procedure.

### BRIEF DESCRIPTION OF THE DRAWINGS

The invention will be more fully understood from the following detailed description taken in conjunction with the accompanying drawings, in which:

FIG. 1 is a schematic depiction of a surgical training system having objective performance assessment in accordance with the present invention;

FIG. 2A is a pictorial representation of a portion of an exemplary embodiment of a surgical training system in accordance with the present invention;

FIG. 2B is a pictorial representation showing further details of the surgical training system of FIG. 2A;

FIG. 2C is a pictorial representation showing further details of the surgical training system of FIG. 2A;

FIG. 3A is a pictorial representation of a sutured training object that can provide realistic haptic feedback during a training procedure on the surgical training system of FIG. 1;

FIG. 3B is a pictorial representation of a further training object that can provide suture training during a procedure on the surgical training system of FIG. 1;

FIG. 3C is a pictorial representation of another training object that can provide surgical training on the system of FIG. 1;

FIG. 4 is pictorial representation of an exemplary embodiment of portions of a surgical training system in accordance with the present invention;

FIG. 5 is a pictorial representation showing exemplary processing in a surgical training system in accordance with the present invention;

FIG. 6 is pictorial representation of a surgical instrument that can form a part of a surgical training system in accordance with the present invention;

FIG. 6A is a pictorial representation showing further details of the instrument of FIG. 6;

FIG. 6B is a pictorial representation of a coupling mechanism that can form a part of the instrument of FIG. 6;

FIG. 6C is a pictorial representation showing a surgical instrument with the coupling mechanism of FIG. 6B;

FIG. 7 is a schematic depiction of an exemplary architecture for a surgical training system in accordance with the present invention;

FIG. 8 is a pictorial representation of a display showing instrument motion in a training procedure for a novice and an expert;

FIG. 9 is a flow diagram showing an exemplary sequence of steps for objectively assessing user performance during a surgical training procedure in accordance with the present invention;

FIG. 10 is a flow diagram showing an exemplary sequence of steps for implementing a path length parameter in accordance with the present invention; and

FIG. 11 is a flow diagram showing an exemplary sequence of steps for computing a motion smoothness parameter in accordance with the present invention.

### DETAILED DESCRIPTION OF THE INVENTION

The invention provides a surgical training system that tracks movement of a surgical instrument to evaluate task performance on one or more objective criteria. Before discussing the details of the invention some higher-level concepts are discussed. By observing how expert surgeons evaluate the performance of a surgeon in training, certain components of a surgical task can be identified that account for competence in relation to instrument motion. Exemplary movement criteria include compact spatial distribution of the tip of the instrument, smooth motion, depth perception, response orientation, and ambidexterity. The time to perform the task, as well as outcome of the task, are two other parameters that can also be included.

These parameters can be transformed into quantitative metrics using kinematics analysis theory. In general, the inventive surgical training system includes a laparoscopic tracking device to measure the time-dependent variables required for analysis, e.g., position of the tip of the instrument, rotation of the instrument about its axis, and degree of opening of the handle. Five exemplary kinematic parameters include elapsed time, path length, motion smoothness, depth perception, and response orientation.

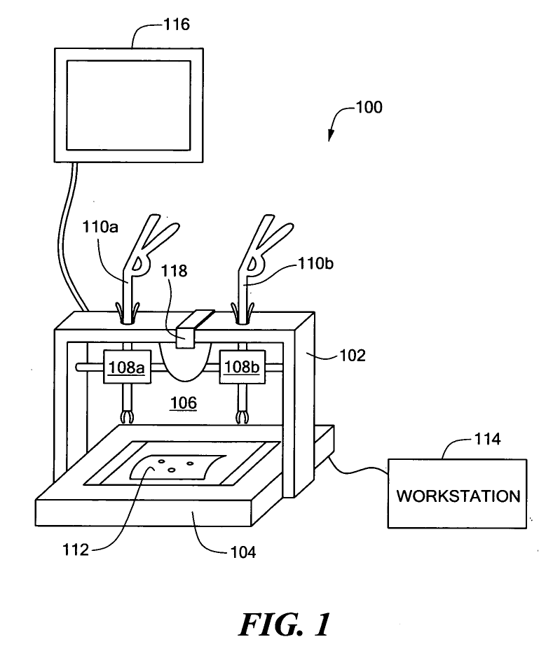

FIG. 1 shows an exemplary computer-based laparoscopic training system 100 in accordance with the present invention. In general, the system 100 includes a mechanical interface, a set of training tasks, a performance assessment system and a user interface. The system 100 tracks instrument position over the course of training procedures and objectively evaluates trainee performance using a series of metrics that use the instrument position information.

The system 100 includes a frame 102 extending from a base 104. An instrument tracking system 106 includes, in an exemplary embodiment, first and second instrument tracking modules 108a,b for tracking the position of respective first and second instruments 110a,b. In one particular embodiment, the position of the tips of the instruments 110 are tracked. However, other instrument locations, features, and the like can be tracked to meet the needs of a particular application.

The instrument tracking modules 108 are secured to the frame and allow movement of the instruments 110 about three axes and rotation for manipulation of a workpiece 112 on the base. The workpiece 112 can comprise an object that simulates human anatomy and provides realistic haptic feedback, as described more fully below. The system 100 also includes a workstation 114 coupled to the tracking modules 108 and a monitor 116 coupled to the workstation. The monitor 116 displays an image of the training region of interest from a camera 118 much like an actual laparoscopic procedure.

Camera and displays for laparoscopic procedures are well known in the art. In one particular embodiment, visual feedback is provided on a conventional monitor using a moveable laparoscopic camera and a light source, such as a Telecam SL NTSC/Xenon 175, by Karl Storz Endoscopy-America, Inc., Culver City, Calif.

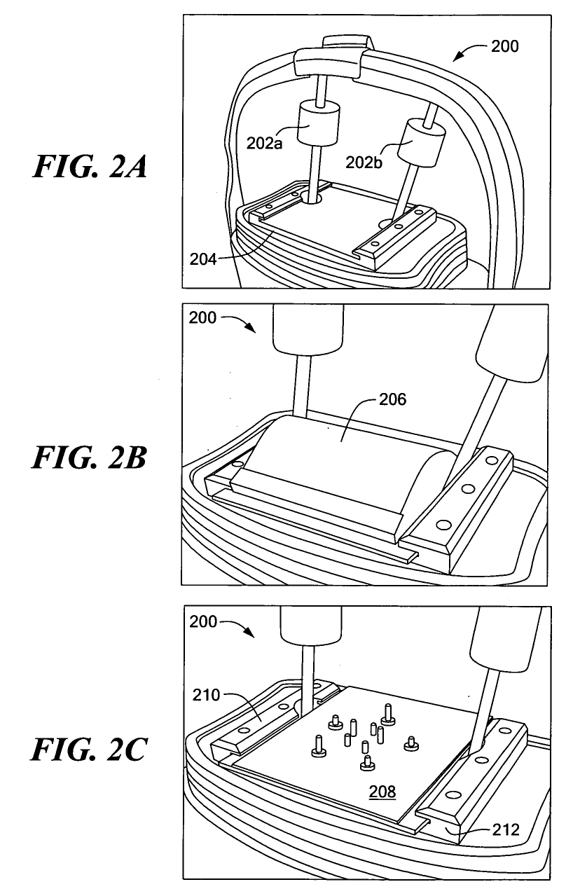

FIGS. 2A-2C show an exemplary embodiment of a surgical training system 200 in accordance with the present invention having first and second instrument tracking modules 202a,202b with a base 204 for supporting various training objects. A workpiece training object 206 is secured on a platform 208 that can be removably secured to the base 204. With this arrangement, a selected workpiece can be secured to the base 204 depending upon the training procedure to be performed.

In one particular embodiment, the system 200 includes a railed locking and alignment mechanism to consistently secure a common task tray or platform, on which the workpiece is affixed. The platform 208 can include rails 210 that are received and held in place by corresponding slots 212 in the base 204. The mechanism can also include a locking mechanism to secure the workpiece. Once the platform is locked in place, the training exercise can proceed without dislodging the task tray from the camera's field of view. Task trays can be easily and quickly changed based upon the selected procedure. In one embodiment, posts extending from the platform are secured by corresponding holes in the workpiece.

In one embodiment, the inventive system uses a set of six swappable skills training task trays developed around the SAGES (Society of American Gastrointestinal Endoscopy Surgeons) laparoscopic skills training tasks. The system incorporates a standardized fixture for securely and consistently holding the varied task trays in referenced position during repeated user testing. In one embodiment, on the bottom of each task tray is a pattern of metallic material which, when fully inserted makes contact with electronic pickups in the base unit and informs the system as to which task tray was just inserted. The base of the unit includes fixed alignment posts that allow the user to recalibrate the orientation of the instrument-shafts without having to fully remove the instruments themselves.

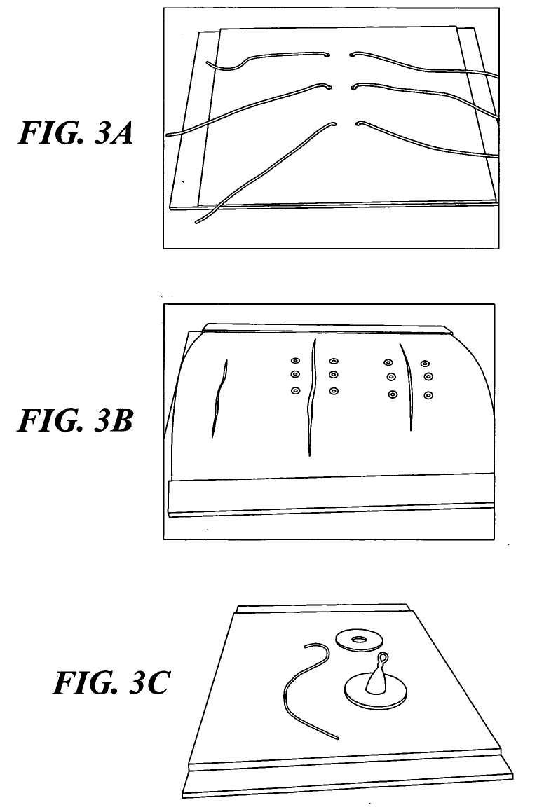

FIGS. 3A-3C show exemplary training objects. FIG. 3A shows surgical sutures arrayed over a simulated skin surface to practice interrupted suturing. FIG. 3B shows a simulated skin injury to train for running suturing. FIG. 3C shows a suture and loop device to practice precise movement coordination.

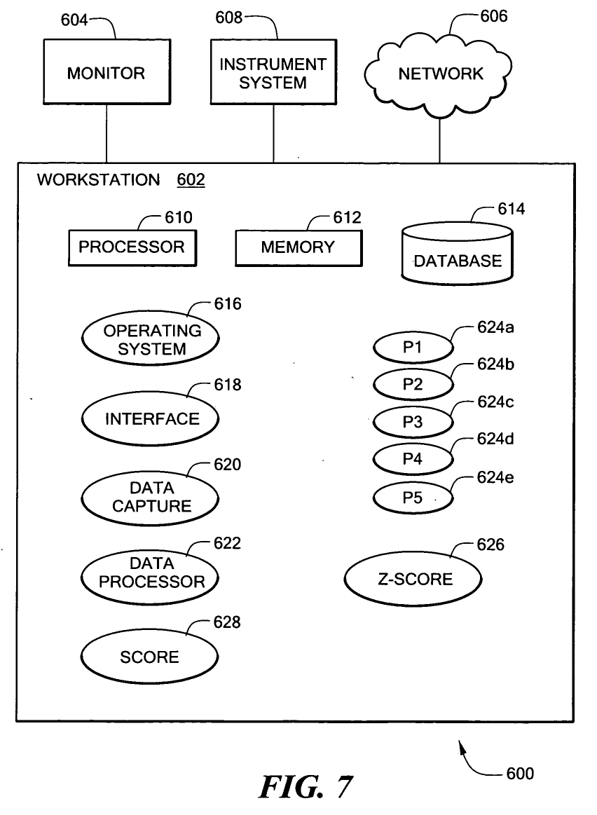

In one embodiment, the workpieces can be purchased from Simulution Company of Prior Lake Minn. as Part Nos. 50103 (FIG. 3A) and 00077 (FIG. 3B). The loop device and weight of FIG. 3C is commonly available.

For example, the workpiece of FIG. 3B is well suited for training a user to suiture a patient using standard laparoscopic instruments, which can be provided as Part Nos. 26173 by Karl Storz of Tuttlingen, Germany, for example. This workpiece provides realistic haptic feedback in that the workpiece “feels” to the trainee much like actual anatomy. It will be appreciated that this enhances the overall training experience.

In an exemplary embodiment, actual laparoscopic instruments, which are modified to enable position tracking, are used. It will be appreciated that the use of actual laparoscopic instruments enhances the realism of the human-instrument interactions encountered during the laparoscopic training operations. In addition, different instruments can be used depending on the training task to be performed.

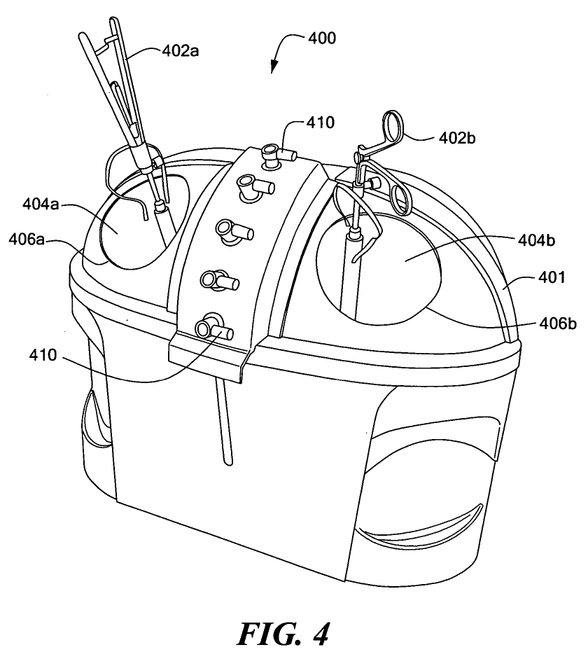

FIG. 4 shows another embodiment of an exemplary surgical training system 400 having an outer frame 401 with first and second instruments 402a, 402b coupled to respective first and second instrument tracking modules 404a, 404b. The instruments 402 are movable within respective trocars with a pair of apertures 406a, 406b in the frame 401 to provide access to the training object. A series of protrusions 408 provide access for a camera. Collets 410 can be used to secure the camera in place.

In one embodiment, the laparoscopic camera is held firmly in place by a mechanically positioned guide provided by the collets 410. Both 10 mm and 5 mm scopes, for example, can be used by adapting the size of camera shaft with the appropriate collet. Each scope collet has locating pins that are used to tell the system which camera has just been inserted into the device. The angle of the camera can be changed by rotating the holding device about its axis via a small knob at the back of the unit. Once the task has been started in the simulator, the position of the camera is electronically fixed at the current position to prevent movement during the procedure.

As described more fully below, a workstation processes the instrument position information over the course of a training procedure to objectively evaluate trainee performance by comparing manipulation of the instruments by the trainee and manipulation by an expert. A mechanical interface provides the ability to track instruments during training procedures. In an exemplary embodiment, the system is capable of tracking the motion of two laparoscopic instruments, while the trainee performs a variety of surgical training tasks. A database is formed by tracking instrument position during training procedures performed by experts. As used herein, an expert is a surgeon that is recognized by peers as being skillful in performing the procedure of interest. Trainee performance is evaluated in comparison to an expert on a series of parameters.

In an exemplary embodiment, the instructor or end user may choose to use a set of tasks from established training programs, such as the Yale Laparoscopic Skills and Suturing Program or the SAGES-Fundamentals of Laparoscopic Surgery training program, which are incorporated herein by reference. Alternatively, a user may develop a custom own set of tasks. Due to the arrangement of the system architecture, new metrics are not required for each new training task since the tasks and standardized performance metrics are independent of each other. One of ordinary skill in the art will recognize this feature as an advantage of the invention over some known training systems.

In general, in order to define a quantitative performance metric that is useful across a large variety of tasks, the way expert surgeons instruct and comment upon the performance of novices in the operating room was examined. Expert surgeons are able to evaluate the performance of a novice by observing the motion of the visible part of the instruments on the video monitor. Based on this information and the outcome of the surgical task, the expert surgeon can qualitatively characterize the overall performance of the novice on the parameters that are required for efficient laparoscopic manipulations. The following components of a task were identified that account for competence while relying only on instrument motion: compact spatial distribution of the tip of the instrument, smooth motion, good depth perception, response orientation, and ambidexterity. Time to perform the task as well as outcome of the task are two other aspects of the “success” of a task that are also included in the computation. Kinematic analysis theory is used to transform these parameters into quantitative metrics.

In one embodiment, five kinematic parameters were defined for the inventive training system. In an exemplary embodiment, they are calculated as cost functions, in which a lower value describes a better performance. A z-score is computed for each parameter, and then the final z-score of a trainee is derived from the z-scores of the individual parameters. A z-score is a statistical tool that is well known to one of ordinary skill in the art. To account for the two laparoscopic instruments a z-score is computed for each instrument and then the two values are averaged, for example. The instructor or the end user is allowed to vary the weights αᵢ of the parameters according to those parameters that are more important or are more relevant in each task.

It is understood that while certain parameters are described herein, it is understood that other parameters not specifically described herein may be apparent to one of ordinary skill in the art without departing from the present invention. In addition, while a Hall-effect sensor tracking system is used in the illustrative embodiments described herein, it is understood that other tracking systems can be used including optical, mechanical, laser, electro-magnetic, and camera based instrument tracking systems.

Exemplary performance parameters include time, path length, motion smoothness, depth perception, and response orientation. The first parameter P₁ elapsed time refers to the total time required to perform the task (whether the task was successful or not). The first parameter can be measured in seconds and represented as P₁=T. A second parameter P₂ refers to the path length, which is the length of the curve described by the tip of the instrument over time. In several exemplary tasks, this parameter describes the spatial distribution of the tip of the laparoscopic instrument in the workspace of the task. A “compact distribution” is characteristic of an expert. It can be measured in centimeters and represented as P₂ in Equation 1 below:

$${P}_{2} = {\int }_{0}^{T} \sqrt{{( \frac{ⅆ x}{ⅆ t} )}^{2} + {( \frac{ⅆ y}{ⅆ t} )}^{2} + {( \frac{ⅆ z}{ⅆ t} )}^{2} ⅆ t} \qquad Eq . ( 1 )$$

where dx/dt refers to displacement along an x axis over time, dy/dt refers to displacement along a y axis over time, and dz/dt refers to displacement along a z axis over time.

A third parameter P₃ refers to motion smoothness, which is based upon the measure of the instantaneous jerk defined as

$$j = \frac{{ⅆ}^{3} x}{ⅆ {t}^{3}} .$$

The instantaneous jerk represents a change of acceleration and can be measured in cm/s³. One can derive a measure of the integrated squared jerk J from j as set forth below in Equation 2:

$$J = \sqrt{\frac{1}{2} {\int }_{0}^{T} {j}^{2} ⅆ t} \qquad Eq . ( 2 )$$

The time-integrated squared jerk is minimal in smooth movements. Because jerk varies with the duration of the task, the jerk measure J should be normalized for different tasks durations, such as by dividing J by the duration T of the task, i.e., P₃=J/T.

The fourth parameter P₄ provides a measure of depth perception, which can be measured as the total distance traveled by the instrument along its axis. This distance can be readily derived from the total path length P₂.

The fifth parameter P₅ provides a measure of response orientation that characterizes the amount of rotation about the axis of the instrument to demonstrate the ability of a user to place the instrument in the proper orientation in tasks involving grasping, clipping, cutting etc. Response orientation P₅ can be measure in radians as set forth below in Equation 3:

$${P}_{5} = \sqrt{{\int }_{0}^{T} \frac{ⅆ {θ}^{2}}{ⅆ t} ⅆ t} \qquad Eq . ( 3 )$$

where dθ/dt represents the displacement in radians about the instrument axis over time.

The above parameters can be seen as cost functions where a lower value describes a better performance. In an exemplary embodiment, task-independence is achieved by computing the z-score of each parameter Pi. The z-score zᵢ corresponding to parameter Pᵢ is defined as follows in Equation 4:

$${z}_{i} = \frac{{P}_{i}^{N} - \overline{{P}_{i}^{E}}}{{σ}_{i}^{E}} \qquad Eq . ( 4 )$$

where \overline{Pᵢ^{E}} is the mean of {Pᵢ} for the expert group and σᵢ^{E} is the standard deviation. Pᵢ^{N} corresponds to the result obtained by the novice for the same parameter. Assuming a normal distribution, 95% of the expert group should have a z-score zᵢε[−2; 2].

In one embodiment, a standardized score is computed from the independent z-scores zᵢ according to Equation 5:

$$z = 1 - \frac{{\sum }_{i = 1}^{N} {α}_{i} {z}_{i}}{{\sum }_{i = 1}^{N} {α}_{i} {z}_{max}} - {α}_{0} {z}_{0} \qquad Eq . ( 5 )$$

where N is the number of parameters, z₀ is a measure of the outcome of the task and α₀ is the weight associated with z₀. Similarly, αᵢ is the coefficient for a particular parameter Pᵢ. The coefficients can be either automatically computed or defined by a user. The coefficients represent the weight assigned to given parameter in computing a final score.

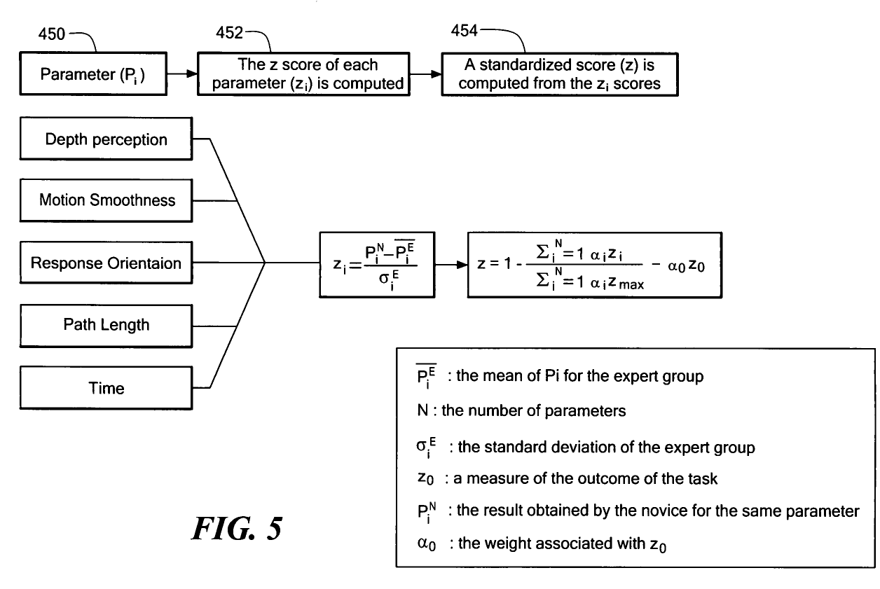

FIG. 5 shows an exemplary process for computing a standardized score for trainees for tasks performed on the inventive training system. In a first processing block 450 a score for each of the five parameters P₁-P₅ described above is determined based upon one or more tasks. In a second processing block 452, the z-score zᵢ of each parameter P₁-P₅ is computed. A standardized score is then computed for the z scores in processing block 454.

While a z-score is used in the illustrative embodiments used herein, it is understood that other suitable statistical tools and techniques will be readily apparent to one of ordinary skill in the art.

The following exemplary function computes the z-score based on the value of a kinematic parameter “Xnovice”, and the values of the mean “MEANexpert” and standard deviation “STDexpert” of the expert group.

```
if (STDexpert < 0.01f)
        // if there is only one expert in the expert group, one
        // cannot have a STD = 0.0
    STDexpert = MEANexpert/20.0f;
        // this means that 2*SD =10% of the mean
        // (and 2*SD -> 95% of the experts if normal
        // distribution)
        // finally, compute z-score
    z = (Xnovice − MEANexpert) / STDexpert;
    if (z < -ZMAX)
        z = -ZMAX;
    if (z > ZMAX)
        z = ZMAX;
    return z;
}
```

In the following function, the values of the variables “meanK1, stdK1, meanK2, stdK2, meanK3, stdK3, meanK4, stdK4, meanK5, stdK5” are directly obtained from the database. The value of “taskOutcome” is set through the user interface at the end of the task. The value ZMAX is a cutoff value/threshold, e.g., 10.0. Z-scores not within the interval [−10, 10] are not considered relevant and set to the minimum or maximum value. The variables “meanK1, . . . meanK5” correspond to the mean of a given parameter Ki for the expert group. Similarly, “stdK1, . . . stdK5” represent the standard deviation for a given parameter Ki for the expery group.

```
    float Kinematics::ComputeNormalizedScore(int taskOutcome)
    {
        float z0, z1, z2, z3, z4, z5;
            // compute z-score for each parameter
        z1 = zScore(_totalTime, meanK1, stdK1);
        z2 = zScore(_pathLength, meanK2, stdK2);
        z3 = zScore(_depthPerception, meanK3, stdK3);
        z4 = zScore(_tremorLevel, meanK4, stdK4);
        z5 = zScore(_rotationAlongToolAxis, meanK5, stdK5);
        if (taskOutcome == 1) // success
            z0 = 0.0;
        else
            z0 = 0.5; // failure
        _normalizedScore = 1.0 − ((z1 + z2 + z3 + z4 + z5) /
(5.0*ZMAX) + z0);
        if (_normalizedScore < 0.0)
            _normalizedScore = 0.0;
        return _normalizedScore;
    }
```

It is understood that a variety of instrument tracking systems can be used to determine the position of the instrument over time. Exemplary tracking technologies include cameras, Hall effect sensors, lasers, radar, sonar, etc.

In one particular embodiment, the instrument tracking modules utilize Hall effect sensors to determine the position of the instrument tip over the course of training procedures. An exemplary Hall effect tracking system is shown and described in U.S. Pat. No. 5,623,582 to Rosenberg, which is incorporated herein by reference. In an exemplary embodiment a suitable tracking system should provide information about five degrees of freedom, e.g., translation along the axis of the shaft (Z axis), rotation about the axis of the shaft, translation in the X and Y direction, and grasping. The five degrees of freedom can also be considered pitch, yaw, roll, translation, and grasping.

As noted above, in one embodiment, the inventive surgical tracking system uses actual full-length instruments in contrast to some known systems that use “cut-off” instruments for which tip position is simulated. Such systems are typically referred to as virtual training systems.

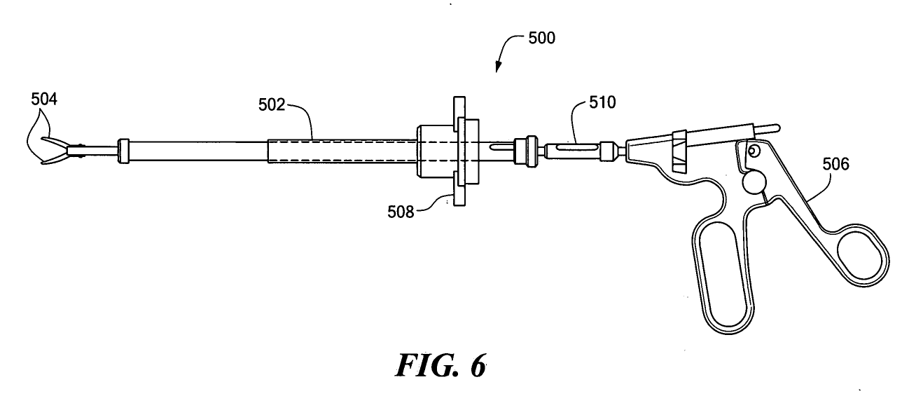

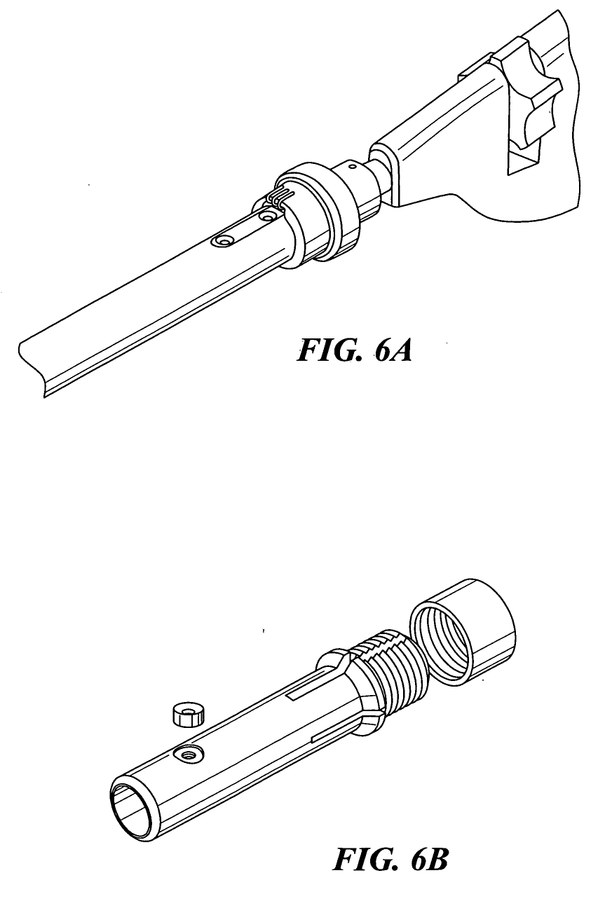

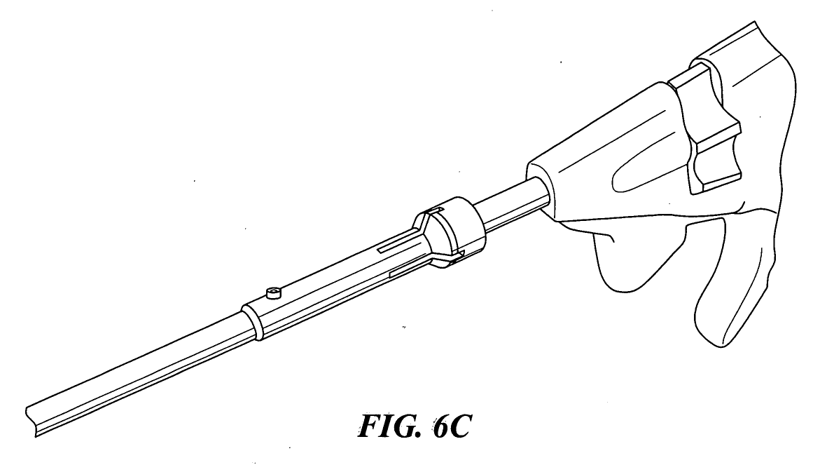

FIG. 6 shows an exemplary laparoscopic instrument 500 having a Hall sensor that can form a part of the inventive surgical training system. The instrument 500 includes a shaft 502 with grasping members 504 at one end and an actuation mechanism 506 at the other end. The shaft 506 enters a receiving tube (trocar) up to a predetermined depth defined by a stop 508.

The hall sensor 510 is used to measure the opening of the actuation mechanism, e.g., the handle, to provide tracking information for grasping position. In one embodiment, the hall sensor 510 is located off-axis from the shaft 502. In one embodiment, the handle and main shaft are replaceable to provide flexibility. With this arrangement, one set of rotary encoders can be used for a variety of instrument types since the same roll and axial motion encoders are available through the use of a tube with the same cross section. This permits the simple exchange of a wide variety of instruments by merely pushing the instrument into new tubes or pulling them out, without additional operations and provides for the proper alignment of the instruments so that a known length of the instrument is inserted into the assembly, and so that the roll axis rotation of the instrument is constrained to a known location with respect to the tube.

Laparoscopic instruments typically include a main, tubular shaft and an inner rod which actuates the end effector. In an exemplary embodiment shown in FIG. 6A, to access the inner rod, the main tubular shaft of an instrument is cut away, and a shaft coupling such as that shown in FIG. 6B, is installed in place of the missing section. An exemplary resulting structure is shown in FIG. 6C. The shaft coupling, together with an alignment tab, ensures that the instruments are inserted to the proper length and that the roll orientation of the instrument coincides with the orientation of the main tube of the assembly. In one embodiment, a set screw with an integral spring-mounted ball bearing is mounted in the wall of the main tubular shaft, close to the proximal end. A small cavity is drilled into each of the shaft couplings (one per instrument). When the instrument is inserted into the main tubular shaft, the spring-mounted ball engages the drilled cavity, removably locking the instrument in place, preventing unintentional removal of the instrument, or loss of axial position (which would distort the Hall sensor measurements).

A variety of alternative mechanisms can be used to secure the coupling including bayonette-style connector between the main tubular shaft and the shaft coupling, requiring a twisting and pulling motion (or pushing and twisting) to remove (or insert) an instrument and a “spring-clip” mechanism, in which a cavity is created in the main tubular shaft, and each shaft coupling has a cantilever-spring-mounted “plug” which seats in the cavity. The retention system should ensure that the instrument is not unintentionally removed from the assembly. It increases the amount of force required to remove the tool from the assembly beyond that imposed by friction within the bearings and encoders. The shaft can also include a limit stop at the bottom end of the main tube, which prevents the main tube from being withdrawn from the system when a user withdraws an instrument. This ensures that position tracking is not lost during an instrument change.

FIG. 7 shows an exemplary architecture for a surgical training system 600 in accordance with the present invention. The system 600 includes a workstation 602 coupled to a monitor 604, a network 606, such as the Internet, and an instrument tracking system 608, such as the system 100 of FIG. 1 or system 400 of FIG. 4. The workstation 602 includes a processor 610 coupled to a memory 612 and a database 614, which can be external to the workstation.

The workstation 602 includes a series of modules that combine to provide the desired functionality. An operating system 616 can be provided as any suitable operating system including Windows-based, Unix-based, and Linux-based systems. An interface module 618 interfaces with the instrument system 608 and other devices. A data capture module 620 communicates with the instrument system to receive instrument tracking system information over the course of a training procedure and store the data in the database 614. A data processing module 622 handles overall processing of the data to compute standardized scores as described above. Further modules 624a-e can compute scores for each parameter to be scored for the procedures performed. A z-score module 626 can compute the z-scores from the parameter scores and a score module 628 can provide a standardized score for user task performance.

In an exemplary embodiment, the position and orientation of each of the two laparoscopic instruments are recorded about every 20 ms. It is understood that position sampling rates can vary to meet the needs of a particular application. Upon completion of the task, the data is filtered using a low-pass filter, and high-order derivatives of the position are computed using a second-order central difference method. Each parameter Pᵢ is then computed from the filtered raw data according to the equations described above, and the normalized score is computed from the parameters Pᵢ and displayed to the user. The score, the parameters Pᵢ as well as the raw data are recorded in the database.

The database 614 maintains user profile information and records information on task performance. In one embodiment, the database system is provided as a public domain package called MySQL that supports ANSI SQL query syntax. With this system, a separate database server process is started on the local machine (or on a remote machine) that listens for database requests from applications. The system can establish a connection to the database server with proper security and then make queries to add or manipulate any records within the approved database.

In one embodiment, the system includes a user database table and a data table. The user table contains the trainee's unique identification number, first and last name, expertise level and email address, etc. This record may be created by the administrator before a user begins training on the system which results in only one record per trainee in the users table indexed uniquely by the user's identification number. The data table can contain a record for each task performed by the user. Exemplary data fields include user identification number, session date and time, task number, complete raw tracking measurements, overall score and computed metric parameters.

In the data database 614, there will be several records per user since they may be performing several tasks on the same day as well on consecutive days. As a result, there is no unique key for data table like the users table. A combination of the user's identification number, date and task number can uniquely identify a particular record. In one embodiment, the raw low-level tracking measurements are stored with a single field in the data record so that metric parameters (current and/or future) can be recomputed at any time from the raw data field.

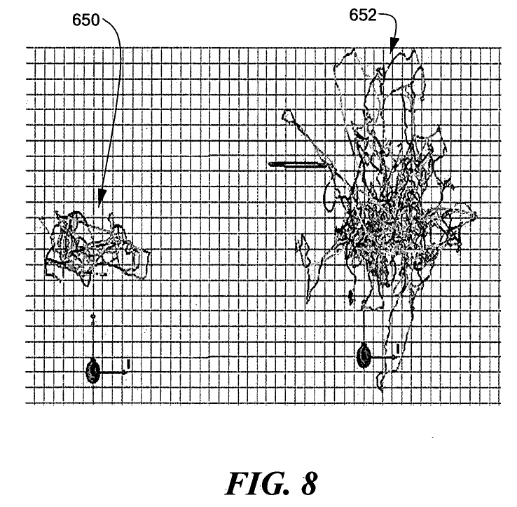

In an exemplary embodiment, the user interface is implemented using C++, FLTK, and OpenGL. The user interface offers real-time display of the tip of the tool, and its path as shown in FIG. 8, which includes an expert performance 650 and a novice performance 652. Kinematics analysis and computation of the score can be performed at the end of the task, providing immediate information to the user. For remote or delayed access to the result of a specific task, the information is saved in a database accessible via a dedicated web site.

In one embodiment, the inventive system includes an Internet interface in order to give maximum flexibility to the user and instructor for reviewing previous tasks. The database information is accessible through a web interface, which can includes a login screen to allow the user to login and access personal data.

It is understood that the various functions can be provided in a wide range of software and hardware partitions using a range of programming language and hardware devices without departing from the present invention. In addition, various modules can be added to achieve further data processing, such as new parameters, to meet the requirements of a given application or task.

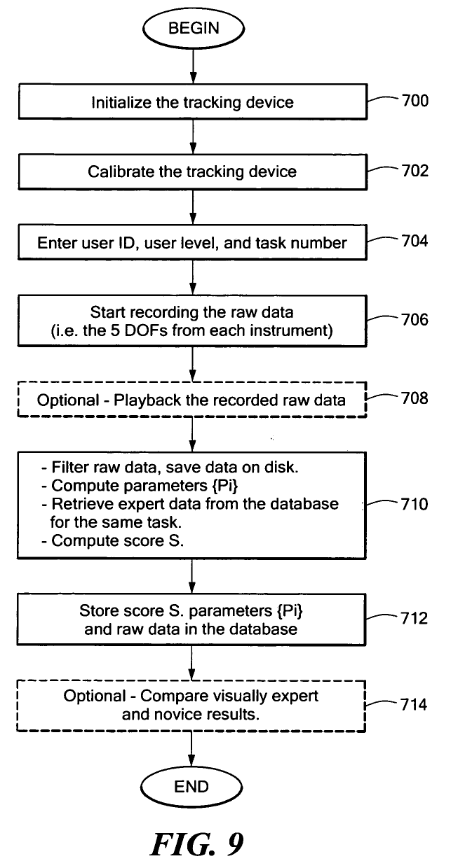

FIG. 9 shows an exemplary sequence of steps for implementing a surgical training system in accordance with the present invention. In step 700, the tracking device is initialized and calibrated in step 702. Through a user interface, in step 704 a user logs in to the system by providing a user ID, a level, and task number, for example.

In step 706, the system starts recording raw instrument position data as the trainee performs the selected training task. Prior to beginning the task, the user or instructor ensures that the correct training object is in place. After recording the raw data can be played in step 708 for review by the user and/or instructor.

In step 710, the raw data is filtered as described above and saved in the database. The parameters, such as the five parameters described above, are computed. Expert data, to which the computed parameter data is compared, is retrieved from the database. The standardized score for the user is then computed.

The user score for the task is then stored in the database in step 712. In step 714, the user results can be optionally compared with expert data.

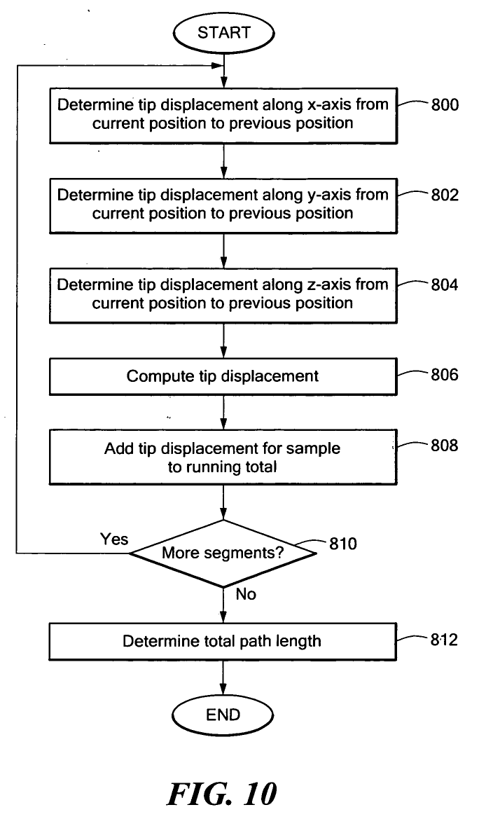

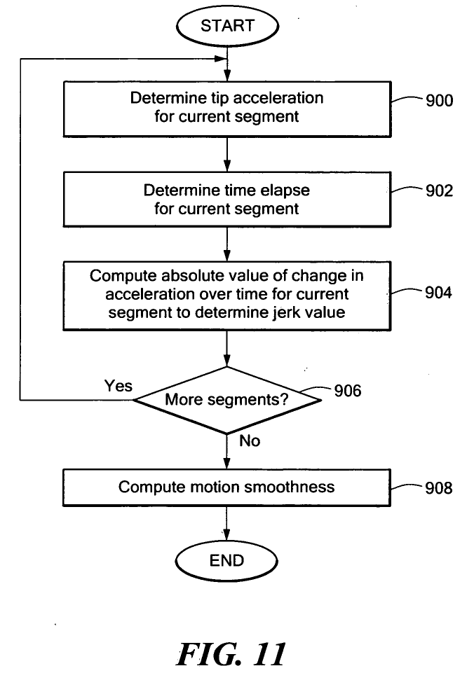

It is understood that various implementations are possible to compute the parameters described above. FIGS. 10 and 11 below show exemplary sequences of steps for computing the given parameter.

FIG. 10 shows an exemplary sequence of steps to implement computing instrument tip path length in accordance with the present invention. In step 800, the tip displacement along an x-axis from a first sample to a second sample, which can be considered a segment, is determined. Similarly, in step 802, tip displacement along a y-axis for a given segment is determined and in step 804 tip displacement along a z-axis is determined for the segment. In an exemplary embodiment, the z-axis corresponds to translation of the instrument along its axis.

In step 806, the actual tip displacement from the segment is computed from the data in three dimensions and in step 808, the displacement for the segment is added to a running total of the displacement the segments. It is determined in step 810 whether there are any additional segments. If so, processing continues in step 800. If not, in step 812 the total tip path length is computed for parameter P₂.

FIG. 11 shows an exemplary sequence of steps to implement computing motion smoothness in accordance with the present invention. In step 900, the tip acceleration is determined for the current segment. As is well known to one of ordinary skill in the art, acceleration corresponds to the change in acceleration over time and velocity corresponds to displacement over time. The elapsed time for the current segment is determined in step 902. In step 904, the absolute value of the change in acceleration over time for the current segment is computed to determine a jerk value for the segment. In an exemplary embodiment, acceleration is computed from sample n+1 to sample n−1.

In step 906, it is determined whether there are further segments. If so, processing continues in step 900. If not, the motion smoothness parameter is computed in step 908 as

$$J = \sqrt{\frac{1}{2} {\int }_{0}^{T} {j}^{2} ⅆ t} .$$

It is understood that the embodiments shown and described herein are adapted for laparoscopic training. However, it will be readily apparent to one of ordinary skill in the art that the invention is applicable to a variety of other surgical training procedures.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A surgical training system, comprising:
a base;
a frame extending from the base;
a first instrument tracking module coupled to the base for tracking a position of a first instrument during a training procedure performed by a user; and
a workstation coupled to the first instrument tracking module for processing position information of the first instrument to objectively analyze performance of the user as compared to one or more experts.

2. The system according to claim 1, wherein the first instrument includes a laparoscopic instrument and a position tracking device.

3. The system according to claim 2, wherein the first instrument tracking module includes a Hall-effect sensor.

4. The system according to claim 1, further including a second instrument tracking module coupled to the workstation to track a position of a second instrument.

5. The system according to claim 1, further including a data processing module to compute a score for one or more parameters based upon the position information of the first instrument over the course of the one or more training procedures.

6. The system according to claim 5, further including at least one parameter processing module selected from an elapsed time module, a path length module, a motion smoothness module, a depth perception module, and a response orientation module.

7. The system according to claim 1, wherein the first instrument tracking system includes sensors to track an instrument in first, second, and third axes and rotation about an axis of the first instrument.

8. The system according to claim 1, further including a training object to provide realistic haptic feedback to the user during the training procedure.

9. The system according to claim 8, further including a platform to support the training object.

10. The system according to claim 8, wherein the training object includes simulated skin.

11. The system according to claim 1, further including a visual feedback system coupled to the frame.

12. A surgical training system, comprising:
a workstation;
an instrument tracking means coupled to the workstation for tracking a position of first and second instruments during a training tack;
a display means for generating visual feedback information for the training task to a user; and
a parameter processing means to compute an objective performance assessment of the training task based upon at least one parameter derived from the instrument position information.

13. The system according to claim 12, further including a database to store instrument position information for the training task.

14. The system according to claim 12, wherein the parameters include one or more of elapsed time, motion smoothness, total path length, response orientation, and depth perception.

15. The system according to claim 12, wherein the instrument tracking means includes at least one Hall sensor.

16. The system according to claim 12, wherein the parameter processing module includes a means to compare the instrument position information of the user to expert information.

17. A method of surgical training, comprising:
tracking a position of a surgical instrument during a training procedure in which a user manipulates a simulated anatomical workpiece providing substantially realistic haptic feedback; and
objectively assessing performance of the user by analyzing position of the surgical instrument during the training procedure by comparison to a position of the surgical instrument during the training procedure derived from experts in the training procedure.

18. The method according to claim 17, further including objectively assessing performance of the user with a series of parameters.

19. The method according to claim 18, wherein the parameters include one or more of depth perception, smoothness, response orientation, path length, and elapsed time.

20. The method according to claim 19, further including assigning weights to the parameters.

21. The method according to claim 19, further including computing a z-score for the parameters.

22. The method according to claim 17, further including providing visual feedback to the user.

23. The method according to claim 17, further including providing the surgical instrument as a full-length laparoscopic instrument.
